(19) United States
(12) Patent Application Publication
(10) Pub. No.: US 2013/0179925 A1
(43) Pub. Date: Jul. 11, 2013

(54) SYSTEMS AND METHODS FOR NAVIGATING THROUGH RELATED CONTENT BASED ON A PROFILE ASSOCIATED WITH A USER

(71) Applicants: Thomas Steven Woods, Arlington Heights, IL (US); Melissa Bradley, Mt. Prospect, IL (US); Ben Fullerton, San Francisco, CA (US); Patrick Newbery, Berkeley, CA (US); Adam Little, San Francisco, CA (US)

(72) Inventors: Thomas Steven Woods, Arlington Heights, IL (US); Melissa Bradley, Mt. Prospect, IL (US); Ben Fullerton, San Francisco, CA (US); Patrick Newbery, Berkeley, CA (US); Adam Little, San Francisco, CA (US)

(73) Assignee: UNITED VIDEO PROPERTIES, INC., Santa Clara, CA (US)

(21) Appl. No.: 13/435,110

(22) Filed: Mar. 30, 2012

Related U.S. Application Data
(60) Provisional application No. 61/583,704, filed on Jan. 6, 2012.

(51) Int. Cl. H04N 21/472; H04N 21/431; H04N 21/4782

(52) U.S. Cl. 725/42; 725/53; 725/51

(57) ABSTRACT

Systems and methods for efficiently navigating through related content based on a profile associated with a user are provided. Content being displayed on the user equipment device from a first media asset received from a first content source of the plurality of content sources to a second media asset received from a second content source of the plurality of content sources is changed based on a first user selection of a first set of navigation keys. A second user selection of the second set of navigation keys is received. The second user selection is received while the second media asset is being displayed. A search for a plurality of content related to the second media asset is performed. A set of the plurality of content corresponding to a profile associated with the user is identified. The identified set is navigated based on the second user selection.

### CROSS-REFERENCE TO RELATED APPLICATION

This application claims the benefit of U.S. Provisional Application No. 61/583,704, filed Jan. 6, 2012, the disclosure of which is hereby incorporated by reference herein in its entirety.

### BACKGROUND

Traditional systems allow a user to access content related to a program being viewed by navigating through a series of menus and options. For example, while watching a program, a user may press a more information key and the system may display a menu that allows the user to select an option to view related content. In addition, the related content that is ultimately displayed may not even interest the user. Thus, traditional systems fail to efficiently enable a user to view content related to a program that is relevant to the user.

### SUMMARY

In view of the foregoing, systems and methods for efficiently navigating through related content based on a profile associated with a user in accordance with various embodiments of the present invention are provided.

In some embodiments, a first media asset may be displayed on a user equipment device. The first media asset may be a video received from a first content source of a plurality (e.g., television channel, a cable source, antenna source, Internet source, satellite source, local storage device, etc.). The plurality of content sources may be arranged in a sequence that is predetermined or user specified (e.g., the sequence of broadcast television channels determined by a distribution facility or a favorite channel sequence selected by the user).

The user equipment device may receive a user selection of one of a first set of navigation keys from a user input device. In some implementations, the user input device may include a first set of navigation keys and a second set of navigation keys. The first set of navigation keys may be up/down keys (e.g., channel change keys) and the second set of keys may be left/right keys. In response to receiving the user selection of one of the first set of navigation keys, the user equipment device may change the first media asset to display a second media asset received from a second content source. The second content source may be a content source that follows or precedes the first content source in the sequence. The user equipment device may retrieve characteristics of the second media asset. The user equipment device may search a content database to identify content having a characteristic that matches the characteristics of the second media asset. The identified content may be determined to be related to the first media asset.

The user equipment device may compare characteristics of the identified content with criteria set in a profile associated with the user. The identified content which is determined to match characteristics of the profile may be added to a list of related content. In some implementations, the list of related content may be sorted or organized according to how strong the matches or scores are between the related content and the profile. In some implementations, the user equipment device may display the list of related content together with the second media asset.

The user equipment device may receive a user selection of one of a second set of navigation keys from a user input device. In response to receiving the user selection of one of the second set of navigation keys, the user equipment device may access the next related content in the list. With the receipt of each subsequent selection of the second set of navigation keys, the user equipment device may continue accessing the next or previous content (depending on whether the selection is the right key or left key) in the list until the end of the list is reached. In some implementations, the user equipment device may display the related content accessed as a result of the user selection of the second set of navigation keys in place of the second media asset or the currently displayed related content.

In some embodiments, a first user equipment device may display a first media asset received from a first source. A second user equipment device may display content related to the first media asset. In some implementations, the second user equipment device may be a tablet and the first user equipment device may be a television screen. In some implementations, a user of the second user equipment device may select the first user equipment device from a plurality. The second user equipment device may determine what media asset is being displayed on the first user equipment device. The second user equipment device may generate a visual representation of the first media asset on the second user equipment device.

In some implementations, the second user equipment device may search for content related to the first media asset. The related content may be filtered based on a profile associated with the user of the second user equipment device. The second user equipment device may sort or organize the related content according to how strong the matches or scores are between the related content and the profile. The second user equipment device may display the sorted related content in a list.

In some implementations, the second user equipment device may organize the display of the related content according to categories or genres or content types. In particular, the second user equipment device may display a first menu that includes related content of one type. In response to receiving with the second user equipment device a first gesture from the user (e.g., a left or right swipe across the screen), the second user equipment device may remove the first menu from the screen and display a second menu that includes related content of a second type. In some embodiments, in response to receiving a second gesture (e.g., an upward or downward swipe down the screen) from the user with the second user equipment device, the second user equipment device may instruct the first user equipment device to change the first media asset. Specifically, the second user equipment device may instruct the first user equipment device to access the next or previous content source in the sequence and display the media asset received from the accessed content source.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIGS. 5 and 6 are illustrative display screens of related content navigation in accordance with another embodiment of the invention;

FIG. 7 is an illustrative display screen of related content in accordance with another embodiment of the invention;

FIGS. 8-10 are illustrative display user profile setup screens for related content navigation in accordance with another embodiment of the invention;

FIGS. 11-13 are illustrative display screens of second screen navigation of related content in accordance with another embodiment of the invention; and

FIGS. 14-16 are diagrams of processes for navigating through related content in accordance with embodiments of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

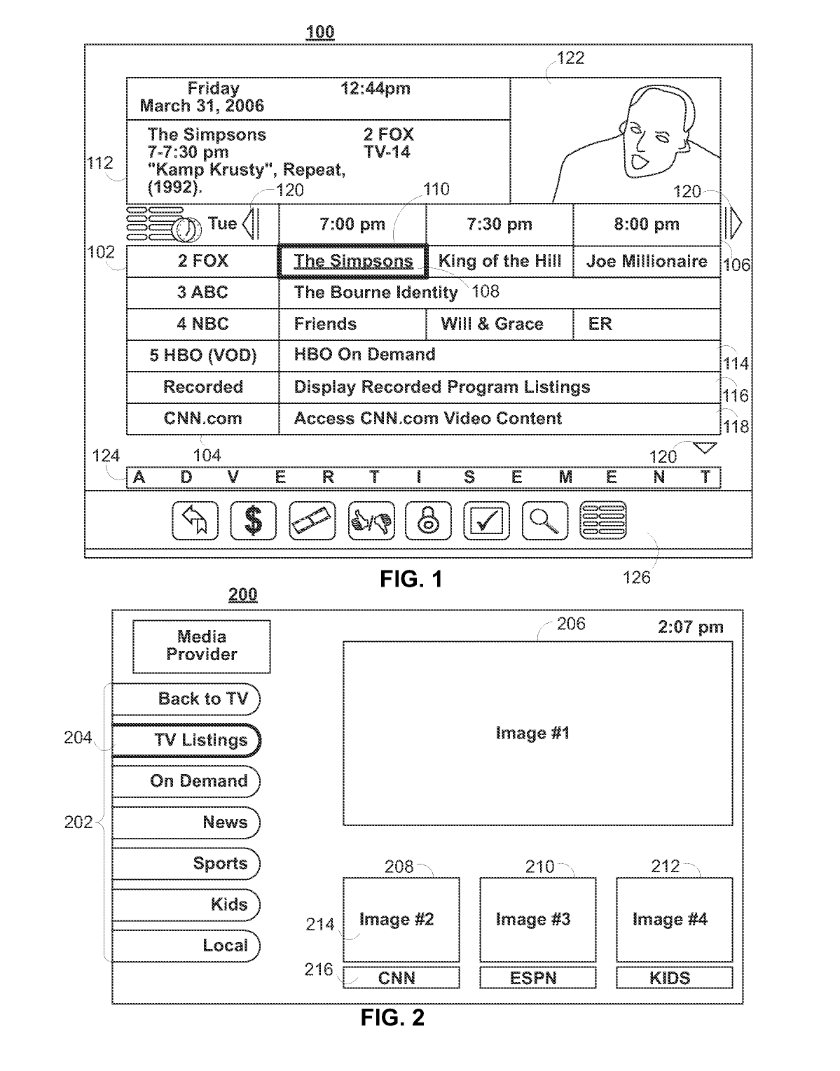

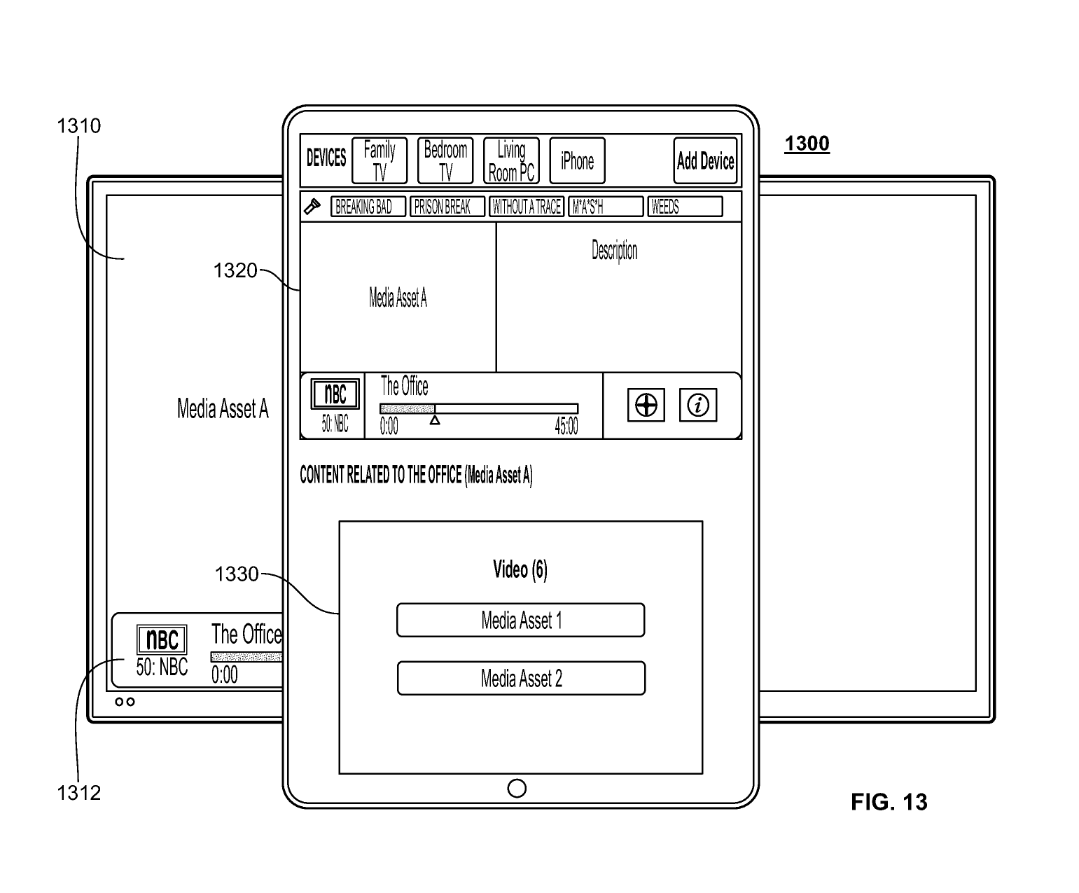

FIGS. 1-2 show illustrative display screens that may be used to provide media guidance data. The display screens shown in FIGS. 1-2 and 5-13 may be implemented on any suitable user equipment device or platform. While the displays of FIGS. 1-2 and 5-13 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

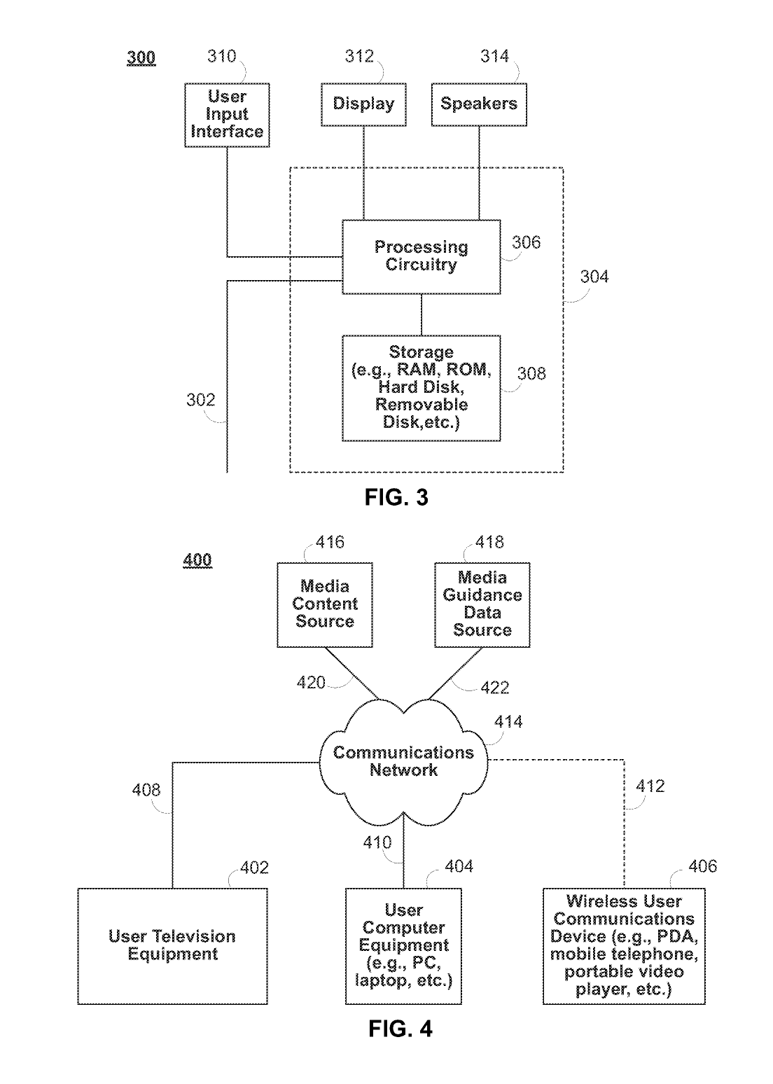

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

In some embodiments, user input interface 310 may include a first set of navigation keys (e.g., up and down keys and/or channel up or channel down keys) and a second set of navigation keys (e.g., left and right keys). Control circuitry 304 may receive an indication from user input interface 310 that a selection of one of the first set of navigation keys (e.g., the up key) was performed by the user. In response, control circuitry 304 may change the content source being accessed or displayed to the next content source in the sequence. For example, control circuitry 304 may change the channel (e.g., television channel) being accessed or displayed to the next channel (e.g., television channel) in the sequence. Similarly, control circuitry 304 may change the video feed from one Internet source (e.g., website) to the next Internet source (e.g., website) in a sequence (e.g., favorite list of video sources or playlist of videos on a given website). In particular, control circuitry 304 may receive content from a plurality of content sources which may be arranged in a sequence (e.g., television channels, favorite channels, favorite websites, video from streaming sources, Internet sources). Control circuitry 304 may change the content being displayed from one of those sources to the next or previous one of the content sources responsive to selection of a corresponding one of the first set of navigation keys (e.g., up key or down key). Specifically, control circuitry 304 may change content or video accessed from content sources responsive to consecutive selections of one of the first set of navigation keys.

In some embodiments, while the media asset is being displayed from a given content source, control circuitry 304 may receive an indication from user input interface 310 that a selection of one of the second set of navigation keys (e.g., the left key) was performed by the user. In response, control circuitry 304 may search for or identify a plurality of content related to the media asset being displayed. In some implementations, control circuitry 304 may search for or identify the plurality of content related to the media asset being displayed once the media asset is accessed. For example, control circuitry 304 may perform the search or identification in response to receiving the user selection of one of the first set of navigation keys (e.g., up key) which caused control circuitry 304 to access content source of the media asset. Control circuitry 304 may search for the related content by computing a Euclidian distance between attributes or characteristics of the media asset and each content. The content may be identified as related content if the computed distance exceeds a threshold value. Control circuitry 304 may filter or narrow the identified content that is related to the media asset based on a profile associated with the user. Control circuitry 304 may filter or narrow the related content by computing a Euclidian distance between attributes or characteristics of the related content and criteria set in the profile associated with the user. The related content may be excluded from a list of related content if the computed distance does not exceed a threshold value. The profile associated with the user may be a user's viewing history, a friend of a user's viewing history, user preferences, and/or any combination of the same. Control circuitry 304 may arrange the identified content that matches the profile associated with the user in a sequence where the first content in the sequence has the strongest match with the profile associated with the user and the last content in the sequence is weakly matched with the profile.

In some embodiments, control circuitry 304 may change the video being displayed on the screen from the media asset to one of the identified plurality of content related to the media asset in response to receiving the user selection of one of the second navigation keys. Specifically, pressing an up key may cause control circuitry 304 to change channels from a first channel to a second channel in the sequence (the next channel) while pressing a left key may cause control circuitry 304 to change channels to the channel corresponding to one of the content sources related to the content displayed by the second channel. With every consecutive selection of the same one of the second set of navigation keys, control circuitry 304 may continue to change the video being displayed to the next related content of the plurality of contents in the sequence. As the user presses the one of the second set of navigation keys, the related content being displayed may correspond to content that is weaker matched with the profile associated with the user. In some embodiments, instead of or in addition to displaying the related content in place of the media asset, representations (e.g., titles) of the related content may be displayed in list (e.g., as an overlay). In response to selection of one of the second set of navigation keys, control circuitry 304 may navigate a cursor to each subsequent content representation in the list.

In some embodiments, control circuitry 304 may be implemented on a second screen device. The related content or list of related content may be displayed on the second screen device while the media asset is displayed on the main screen. Control circuitry 304 may allow the user to perform gestures using the second screen device to navigate between the related content. For example, control circuitry 304 may receive a left swipe across the screen as a gesture with the second device. In response, control circuitry 304 may perform the same or similar functions as selection of one of the second set of navigation keys. Similarly, control circuitry 304 may receive an up swipe across the screen (e.g., a sliding motion across the screen in a substantially perpendicular direction to the left swipe) as a gesture with the second device. In response, control circuitry 304 may perform the same or similar functions as selection of one of the first set of navigation keys. The second screen device may display the media asset or a representation of the media asset being displayed on the main screen. For example, the main screen may be a first user equipment device and the second screen device may be a second user equipment device. In such circumstances, the second screen device may determine what media asset is being displayed on the first user equipment device and display a representation (e.g., video) of the media asset as well as content related to the media asset.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on his/her personal computer at his/her office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry 304 may receive a user selection of a first set of navigation keys (e.g., a channel change key/command). In response, control circuitry 304 may change the content source being accessed to a next content source in a sequence to display a media asset. Control circuitry 304 may search for a plurality of content related to the media asset and display the related content upon receiving a user selection of a second set of navigation keys (e.g., left/right key).

For simplicity and not limitation, the phrase “media asset” will be used to refer the content being displayed on a user equipment device that is received from a content source when the user uses a first set of navigation keys (e.g., a channel tuned to based on a channel up/down selection). For simplicity and not limitation, the phrase “related content” or “plurality of content related to the media asset” refers to the content that is related to the displayed media asset which is accessed when the user uses a second set of navigation keys (e.g., a channel related to the media asset being displayed accessed based on a left/right selection).

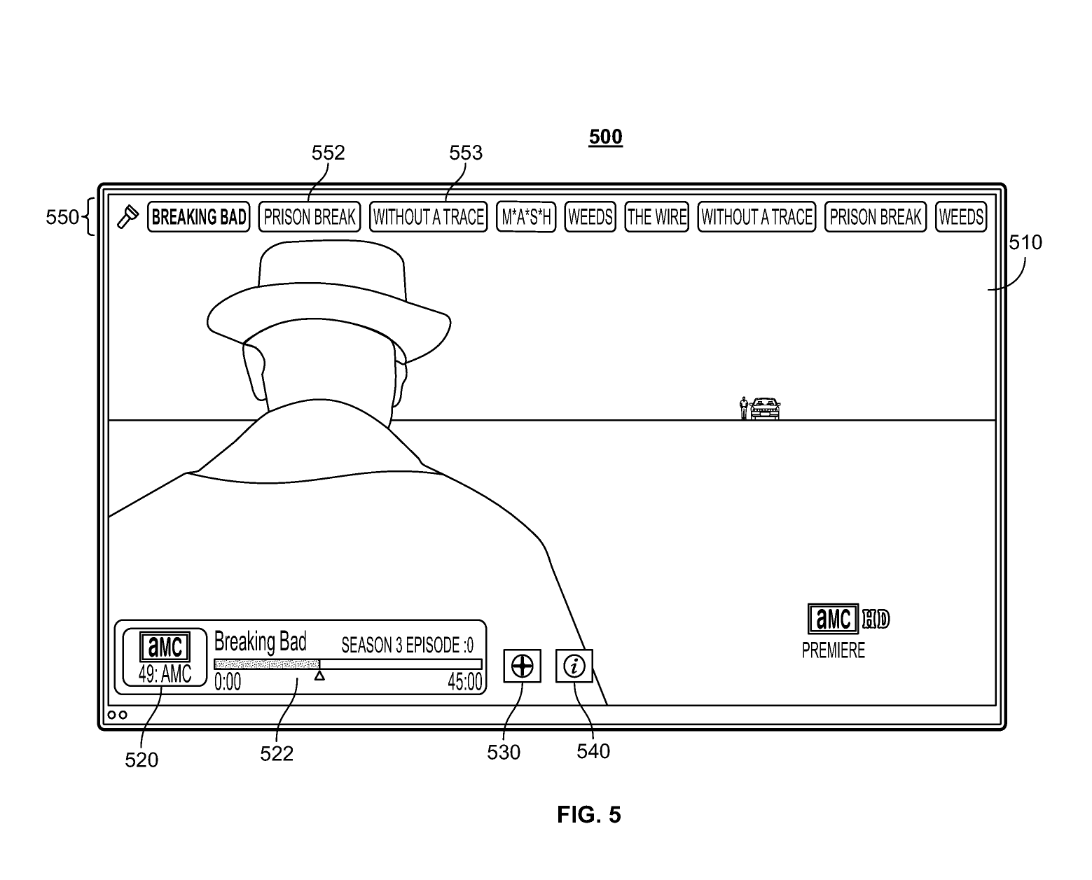

FIG. 5 is an illustrative display screen 500 of related content navigation in accordance with embodiments of the invention. Screen 500 includes a first media asset 510, information region 520 and a related content region 550. For example, screen 500 may be displayed when (or after) control circuitry 304 receives a user selection of program listing 108 (FIG. 1). In some implementations, screen 500 may be displayed when the user manually identifies a content source (e.g., selects a channel). Control circuitry 304 may access (e.g., tune to or navigate to) the content source identified by the user or corresponding to program listing 108 selected by the user. In some implementations, first media asset 510 may be a video that is received from the content source that is accessed by the user equipment device.

Information region 520 may include information that identifies first media asset 510 to a user. For example, information region 520 may includes a content source identifier (e.g., channel name and number, such as channel 49, AMC), title and a transport bar. The content source identifier may include an indication of the type of content source (e.g., Internet content source, television content source, satellite content source, cable content source, or any combination thereof). The title displayed in information region 520 may be the title of first media asset 510 (e.g., Breaking Bad). Transport bar 522 may include an indication of the running time of first media asset 510. For example, transport bar 522 may include a first region that may be shaded to indicate how much of first media asset 510 has elapsed and a second region that may indicate how much time remains in first media asset 510.

When first media asset 510 is displayed, control circuitry 304 may automatically retrieve information associated with first media asset 510 from storage 304. For example, control circuitry 304 may retrieve a data structure associated with first media asset 510 from storage 304. Alternatively, control circuitry 304 may search the Internet or a remote source for information associated with first media asset 510. The information associated with first media asset 510 may include a detailed description, categories associated with first media asset 510, characteristics of first media asset 510, a list of content related to first media asset 510, title information, series information, or episode information of first media asset 510, or any other data that is associated with first media asset 510 or any combination of the same.

Control circuitry 304 may process the retrieved information associated with first media asset 510 to identify media content that is related to first media asset 510. For example, control circuitry 304 may extract from the information characteristics of first media asset 510. Control circuitry 304 may search a local or remote database (e.g., over the Internet) for content that is associated with the same characteristics as first media asset 510. Control circuitry 304 may process the content that is associated with the same characteristics as first media asst 510 to determine whether the content is currently available (e.g., the content is currently being broadcast or is about to be broadcast). For example, control circuitry 304 may determine whether the content is scheduled for transmission to the user equipment device at or about the current time. In some embodiments, the content may be available over the Internet anytime and/or may be on-demand. In such circumstances, control circuitry 304 may mark that type of content as currently available. Control circuitry 304 may eliminate from the list of content that is associated with the same characteristics as first media asset 510 that content which is not currently available (e.g., are scheduled for transmission in a future time, or are available for ordering now but not available for download until a future time). In some embodiments, the user may configure control circuitry 304 to include in the list content regardless of whether it is currently available.

Control circuitry 304 may compile a list of the identified content that shares characteristics with first media asset 510 and that is currently available and organize the list according to how strong the match is between first media asset 510 and each identified content. Control circuitry 304 may store the list as the list of related content associated with first media asset 510. In some embodiments, control circuitry 304 may include the content that is currently available at the top of the list and the content that is available in the future at the bottom of the list (e.g., control circuitry 304 may also sort the list according to content availability times).

In some embodiments, control circuitry 304 may retrieve from storage 304 a profile associated with the user. The user may be the person or persons watching first media asset 510 on the user equipment device. Control circuitry 304 may process the profile to identify criteria set by a user that define the user's interests. In some implementations, the user may include multiple users in a room and, accordingly, control circuitry 304 may process profiles associated with all of the users in the room together to identify the criteria. In some embodiments, the profile may include a viewing history associated with the user which includes a list of media assets the user previously accessed for a predetermined length of time. In some embodiments, the profile may include a viewing history of another user associated with the user (e.g., a friend of the user) which includes a list of media assets the friend of the user previously accessed for a predetermined length of time. The profile may include characteristics and levels of like/dislike for each of those characteristics. The characteristics may include content characteristics and/or content source characteristics.

In some implementations, control circuitry 304 may retrieve the profile information and determine which of the related content in the list matches criteria set by the profile. For example, the profile may indicate a user's strong preference for comedies and a weak preference for dramas. Accordingly, control circuitry 304 may eliminate from the related content list each related content which is associated with a drama characteristic. Similarly, the viewing history in the profile may indicate that the user watches action movies more than any other category of movies. Accordingly, control circuitry 304 may eliminate from the related content list each related content which is associated with a characteristic that is not action. The profile may indicate that the user has a strong interest in a friend's preference for content. In such circumstances, control circuitry 304 may retrieve the viewing history of the friend and determine what type of content the friend watches most. Control circuitry 304 may eliminate from the related content list any content that does not share characteristics with the type of content the friend watches. The creation of the profile associated with the user is discussed in more detail below.

Control circuitry 304 may sort or organize the related content list according to the strength of the relationship between each content in the list with the profile associated with the user. For example, the content at the top of the list may have the strongest match between the criteria set by the profile and the content characteristics, whereas the content at the bottom of the list may have the weakest match between the criteria set by the profile and the content characteristics.

Related content region 550 may display representations of the list of content related to first media asset 510 that matches a profile associated with the user. Related content region 550 may be displayed as a translucent, opaque or partially translucent overlay on top of first media asset 510. Related content region 550 may be displayed automatically when first media asset 510 is displayed. For example, related content region 550 may be displayed in response to the user requesting to access the content source of first media asset 510. The representations in region 550 may include a title of each content in the list, a video of each content, a video clip, an image, a textual description, a link to a website, a URL, or any combination of the same. The representations may be displayed in the order of appearance in the related content list. For example, first related content representation 552 may be associated with a first content (e.g., “Prison Break” media asset) and second related content representation 553 may be associated with a second content (e.g., “Without A Trace” media asset). First content may match criteria set in the profile associated with the user better than second content. This may be because the first content may be associated with a content characteristic (e.g., comedy) which the profile associated with the user indicates the user has a high preference for and which the second content lacks.

In response to receiving a user selection of one of a second set of navigation keys (e.g., left key) of user input interface 310, control circuitry 304 may navigate consecutively between each content in the related content list. For example, region 550 may indicate that first media asset 510 (e.g., “Breaking Bad”) is currently being accessed from the first content source. In response to receiving a user selection of a right navigation key, control circuitry 304 may navigate to the first related content listed in region 550 (e.g., related content 552). For example, control circuitry 304 may access the content source associated with related content 552 in response to receiving the user selection of the right navigation key. In some implementations, control circuitry 304 may display related content 552 in place of first media asset 510. In some implementations, control circuitry 304 may display related content 552 on top of first media asset 510 as an overlay. In response to receiving another user selection of right navigation key, control circuitry may navigate to the next related content listed in region 550 (e.g., related content 553). For example, control circuitry 304 may access the content source associated with related content 553 in response to receiving the second user selection of the right navigation key. With each successive selection of the right navigation key, control circuitry 304 may continue to access and display the related content subsequently listed in the list.

In response to receiving a user selection of a left navigation key (e.g., a user selection of a second one of the second navigation keys of user input interface 310), control circuitry 304 may navigate back to related content listed in region 550 previous to the currently displayed related content. For example, when related content 553 is currently being displayed, control circuitry 304 may access the content source associated with related content 552 in response to receiving the user selection of the left navigation key. In some implementations, control circuitry 304 may display related content 552 in place of first media asset 510.

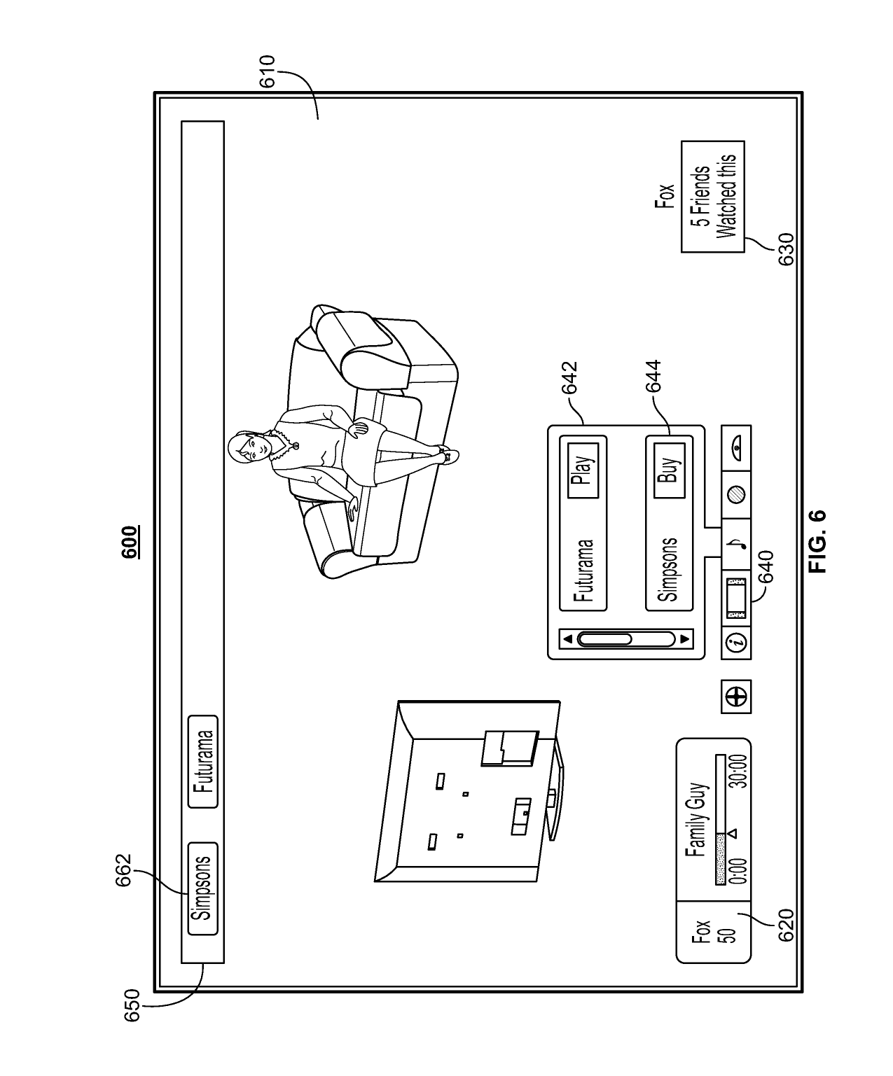

Interactive related content indicators 530 and 540 may indicate the availability of content related to first media asset 510. Control circuitry 304 may receive a user selection of related content indicators 530 and 540 and may in response display menus allowing the user to navigate through the related content. The related content displayed in menus when indicators 530 and 540 are selected may be selected based on characteristics of first media asset 510 and based on a profile associated with the user. Indicator 530 may be selected by pressing a dedicated key on user input interface 310. Control circuitry 304 may display the related content list organized according to a category or genre of the related content when indicator 530 is selected. Indicator 540 may be selected by pressing another dedicated key on user input interface 310. Control circuitry 304 may display the related content list organized according to type (e.g., music, movies, on-demand, text, etc.) of the related content when indicator 540 is selected. Control circuitry 304 may display related content menu 640 when the user selects indicator 530 or 540 (FIG. 6).

Content sources being accessed to display a media asset with user equipment device may be organized in a list. For example, content sources may be organized by a content provider or distribution facility where channels of the content sources are arranged in ascending order or according to categories. In some implementations, the list of content sources may be re-arranged based on user preferences. Specifically, the list of content sources may be a subset of all available channels that the user selects as the favorite tuning sequence. The access of content through the list of content sources discussed herein should be understood to refer to any currently active content source list (e.g., a favorite content source list or the full list of content sources arranged according to some criteria).

In response to receiving a user selection of one of a first set of navigation keys (e.g., up key or channel change key) of user input interface 310, control circuitry 304 may access a next content source in the list of content sources. Control circuitry 304 may change display of first media asset 510 received from a first of the content sources to a second media asset 610 received from the next content source in the list (e.g., the next content source in the sequence). For example, control circuitry 304 may receive a channel up command from user input interface 310 and, in response, control circuitry 304 may change the currently tuned channel (e.g., AMC on channel 49) to tune to the next channel (e.g., FOX on channel 50) in a sequence of channels. In some implementations, the list of content sources may be a playlist of media assets. In such circumstances, responsive to receiving a user selection of one of the first set of navigation keys, control circuitry 304 may access the next media asset in the playlist.

FIG. 6 is an illustrative display screen 600 of related content navigation in accordance with embodiments of the invention. Screen 600 includes a second media asset 610 that may be displayed after first media asset 510 in response to receiving a user selection of a first set of navigation keys. When control circuitry 304 displays second media asset 610, control circuitry 304 may search for content related to second media asset 610. Control circuitry 304 may determine from the related media content which media content matches criteria defined by a profile associated with the user. This process may be performed in the same or similar manner as that described above in connection with FIG. 5. Control circuitry 304 may display the related media content in related content region 650.

In some implementations, control circuitry 304 may search for media content related to the media asset being displayed with user equipment device in response to receiving a user selection of the first set of navigation keys (e.g., channel change key). Control circuitry 304 may update the displayed media asset to display the media asset received from the next or previous content source. Control circuitry 304 may also update related content region 550 or 650 to display representations of content related to the displayed media asset.

In response to receiving a user selection of the second set of navigation keys (e.g., left or right key), control circuitry 304 may display the next related content in the list (represented in region 550 or 650) but may not search for media content related to the related content being displayed. Specifically, control circuitry 304 may identify related content that corresponds to the media asset being displayed only when the user selection that caused the media asset to be displayed is a selection of one of the first navigation keys and not when the user selection is a selection of one of the second navigation keys. The first navigation keys may instruct control circuitry 304 to change the content source and update the search while the second navigation keys may instruct control circuitry to navigate between the identified related content. In some embodiments, selection of either first or second set of navigation keys may cause control circuitry 304 to change the content or media asset being displayed and search for content related to the media asset being displayed.

Media asset information region 620 may display the same type of information as region 520 (FIG. 5). Specifically, region 620 indicates that the currently displayed second media asset 610 is being received from a second content source (e.g., FOX on channel 50) and that the title of second media asset 610 is “Family Guy.” The second content source identified in region 620 may be the next channel up from the content source identified in region 520. In particular, the content source identified in region 520 may be channel 49 and in response to receiving a user selection of the first set of navigation keys (e.g., channel up key), the next content source may be accessed by control circuitry 304 (e.g., channel 50).

In response to accessing the second content source, control circuitry 304 may search for content related to second media asset 610. Control circuitry 304 may also determine which of the related media content matches criteria of a profile associated with the user.

The related content may be arranged in a sorted list and representations of the related content may be displayed in region 650. For example, second media asset 610 may be a video of the show Family Guy and the related content may be currently available shows that relate to Family Guy (e.g., share a content characteristic with Family Guy). The related content list may include the shows Simpsons and Futurama. In response to receiving a user selection of the second set of navigation keys, control circuitry 304 may navigate to and display each of the related content in region 662. For example, in response to receiving a user selection of the second set of keys (e.g., a right key), control circuitry 304 may access the content source corresponding to the next show in the related content list (e.g., the content source corresponding to Simpsons). A visual indicator 662 may indicate to the user which of the related content is being displayed on the user equipment device. A similar or the same visual indicator may also be provided on the display to indicate that the content being presented on the display was navigated to and displayed as a result of receiving the user selection of the second set of navigation keys instead of the first set of navigation keys. For example, an indicator may be displayed persistently or for a predetermined amount of time identifying the content being displayed as “related content” rather than a media asset that was selected due to receiving a user selection of the first set of navigation keys.

In some embodiments, in response to receiving a first user selection of the second set of navigation keys (e.g., left or right key), control circuitry 304 may expand indicator 540 to display related content menu 640. In some implementations, related content menu 640 may be displayed by control circuitry 304 responsive to receiving a user selection of a dedicated key on user input device 310. Related content menu 640 may include indicators that are shaped to identify related content by type. For example, each indicator in menu 640 may be associated with a different set of related content that is of a given type. The related content which each indicator in menu 640 is associated with may be restricted to related content that matches criteria defined in a profile associated with the user. In particular, a first indicator in menu 640 may be associated with video content, a second indicator in menu 640 may be associated with audio content, a third indicator in menu 640 may be associated with textual content, a fourth indicator in menu 640 may be associated with Internet content (e.g., websites), and a fifth indicator in menu 640 may be associated with assets of a particular class or genre. It should be understood that although only four such indicators are drawn in FIG. 6, menu 640 may include any number of indicators associated with related content.

In response to receiving subsequent selection of the second set of navigation keys, control circuitry 304 may navigate between each indicator in menu 640. For example, in response to receiving a first selection of the second set of navigation keys, control circuitry 304 may navigate to a first indicator associated with movie content. In response to receiving a second selection of the second set of navigation keys, control circuitry 304 may navigate to a second indicator associated with audio content. As control circuitry 304 navigates to each indicator in menu 640, control circuitry 304 may display an interactive window 642 that includes the related content of the type with which the indicator is associated. For example, when control circuitry 304 is instructed to navigate to the audio indicator in menu 640, control circuitry 304 may display in window 642 audio content listings 644 that are related to second media asset 610 and that match criteria set in the profile associated with the user. Each content listing 644 may be interactive to allow the user to select the given content listing to access the content corresponding to the listing. In some implementations, the content listing may be associated with content that requires purchase authorization. In such scenarios, control circuitry 304 may query the user for purchase information (e.g., credit card information or a username and password) before receiving authorization to access the selected content.

In some embodiments, the related content listed in window 644 may be the same or different from related content listed in region 650. Specifically, the representation of related content listed in region 650 may correspond to only related content that is currently available for access (e.g., display) by the user equipment device. The related content listings in window 642 may correspond to related content that is not currently available for access (e.g., requires purchase authorization or is available in the future). When a related content listing that corresponds to a future content is selected using window 642, control circuitry 304 may query the user whether the user would like to schedule a reminder or a recording for the selected content. In response to the query, control circuitry 304 may be instructed to schedule the reminder or the recording of the related content corresponding to the selected listing and hide menu 640 from the display.

In some embodiments, control circuitry 304 may analyze or process viewing histories of one or more friends of the user to determine what media assets they have viewed or are currently viewing. Control circuitry 304 may retrieve the viewing histories of the one or more friends by accessing a social network website of the user. The social network site may maintain viewing histories of various users. Control circuitry 304 may identify friends of the user and retrieve their corresponding viewing histories. Control circuitry 304 may search the retrieved viewing histories of the one or more friends to determine whether second media asset 610 is included in their viewing histories. Control circuitry 304 may count the number of viewing histories which include second media asset 610. Control circuitry 304 may generate for display an indicator 630 that informs the user of how many friends of the user have previously watched or are currently watching second media asset 610.

In some embodiments, control circuitry 304 may display the media asset and related content in a multi-part configuration. Specifically, the media asset may be displayed in a video window (e.g., a region in the display smaller than the full screen). Representations of the related content may be displayed along the top portion of the display. Another part of the display may be configured to display information associated with the media asset displayed in the video window and another part of the display may display additional media content related to the currently displayed media asset.

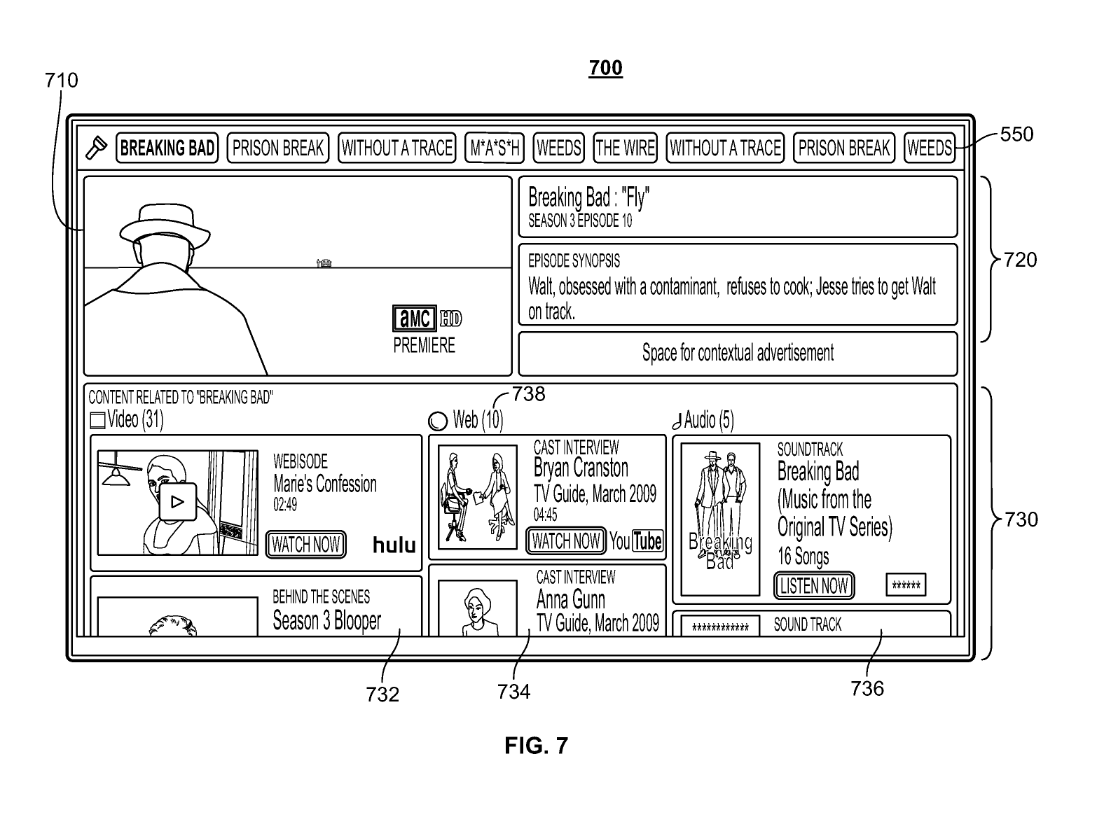

FIG. 7 is an illustrative display screen 700 of related content in accordance with another embodiment of the invention. Screen 700 may include related content region 550, a media asset window 710, media asset information region 720 and a second related content region 730. Screen 700 may include all the functionality discussed above in connection with FIGS. 5 and 6 except the media asset being accessed from a content source is displayed in media asset window 710 instead of the full screen display.

In response to control circuitry 304 receiving a user selection of one of the first set of navigation keys (e.g., up or down key), control circuitry 304 may access the next content source and display the media asset from that content source in media asset window 710. As further selections of the first set of navigation keys are received, control circuitry 304 may access subsequent content sources and display the media asset from the respective content sources in media asset window 710. For each media asset displayed in media asset window 710, control circuitry 304 may retrieve media asset information (e.g., detailed description, clips, advertisements, promotional information, title, series or episode information, etc.) from storage 308 and display the retrieved information in media asset information region 720.

In response to control circuitry 304 receiving a user selection of one of the second set of navigation keys (left or right key), control circuitry 304 may access the next related content in the list of related content and display the related content in window 710 or in another portion of the display (e.g., as an overlay on top of screen 700). The related content displayed in region 730 may be the same or different than the related content representations displayed in region 550. Specifically, second related content region 730 may include the same or similar functionality as menu 640. In some implementations, instead of displaying the related content for each indicator of menu 640 when that indicator is navigated to by the user, control circuitry 304 may display multiple related contents according to their types simultaneously. The related content representations displayed in region 550 and region 730 may correspond to criteria set by a profile associated with the user. The manner in which the related content is identified may be performed in the same or similar manner as discussed above in connection with FIGS. 5 and 6.

For example, control circuitry 304 may display a first set of related content in region 732 that is of a video type. Control circuitry 304 may display a second set of related content in region 734 that is of an website type. Control circuitry 304 may display a third set of related content in region 736 that is of an audio type. Control circuitry 304 may receive a user selection of any content displayed in regions 732, 734 and 736 and in response may access the content immediately (e.g., display the content in window 710) and/or allow the user to schedule a reminder and/or recording of the corresponding content. Each region 732, 734 and 736 may include a respective identifier 738 that indicates how many contents (e.g., the number of videos) that are included the respective region 732, 734 and 736.

In some embodiments, a user may set up criteria for a profile associated with the user to enable control circuitry 304 to identify content that is related to a currently displayed media asset and relevant to the user. The criteria may include multiple parameters that include preferences of the user for specific types of content, media types, sources and friends of the user.

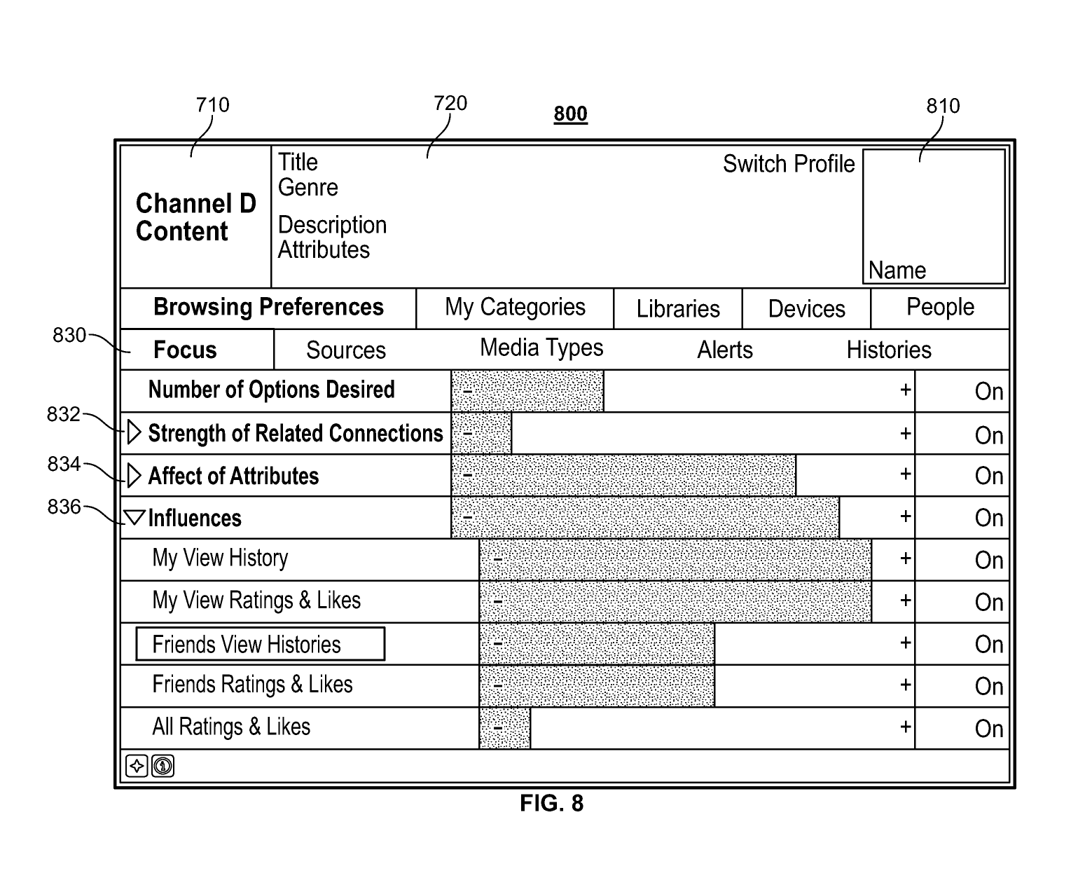

FIGS. 8-10 are illustrative display user profile setup screens 800-1000 for related content navigation in accordance with another embodiment of the invention. Screen 800 includes a user identifier 810 and criteria selection region 830. User identifier 810 may include an image, video, icon, text, graphic or any other representation of the user that informs the user to which user profile the criteria corresponds.

Control circuitry 304 may receive a user selection of focus option in criteria selection region 830. In response, control circuitry 304 may display a set of preferences which the user may modify to indicate a level of like or dislike for a given attribute. Specifically, the preferences corresponding to the focus options indicate to control circuitry 304 how to rank the preferences of the user when determining whether related content matches criteria set in a profile associated with the user. For example, one preference may allow the user to indicate to control circuitry 304 how many preferences control circuitry 304 should consider when analyzing whether related content matches the criteria in the profile. Control circuitry 304 may receive a user modification to strength of related connections preference 832. The modification to preference 832 may indicate to control circuitry 304 a minimum threshold which related content characteristics have to exceed when compared with criteria set in the profile in order to be included in the related content list and/or when ranking or sorting the related content in the related content list. The user may increase or decrease the level of like or dislike for preference 832 using the second set of navigation keys.

Control circuitry 304 may receive a user modification to affect attributes preference 834. The modification to preference 834 may indicate to control circuitry 304 whether to give more weight or less weight to criteria set in the profile when compared against the strength of the connections between the related content and the media asset in determining whether the related content should be included in the related content list and/or when ranking or sorting the related content in the related content list. For example, a score for a strength of the connection between a related content and the media asset may be computed to be 25 while the score between the profile and the related content may be computed to be 20. When preference 834 is set to very low level of like, control circuitry 304 may include the related content in the related content list or may rank it very high even though the match to the profile is weaker or lower than the match between the related content and the media asset. The user may increase or decrease the level of like or dislike for preference 834 using the second set of navigation keys.

Control circuitry 304 may receive a user modification to influences preference 836. The modification to preference 836 may indicate to control circuitry 304 how much weight to give different profile settings and friend's settings when determining whether the related content should be included in the related content list and/or when ranking or sorting the related content in the related content list. For example, the user may specify a greater level of preference or like for the user's own viewing history over a friend's viewing history. In such circumstances, control circuitry 304 may give more weight to the user's viewing history than the friend's viewing history when determining whether to include related content in the list of related content and/or when ranking or sorting the related content in the related content list. Similarly, the user may specify a greater level of preference or like for the user's own ratings and preferences over a friend's ratings and preferences. In such circumstances, control circuitry 304 may give more weight to the user's ratings and preferences than the friend's ratings and preferences when determining whether to include related content in the list of related content and/or when ranking or sorting the related content in the related content list. The user may increase or decrease the level of like or dislike for preference 836 using the second set of navigation keys.

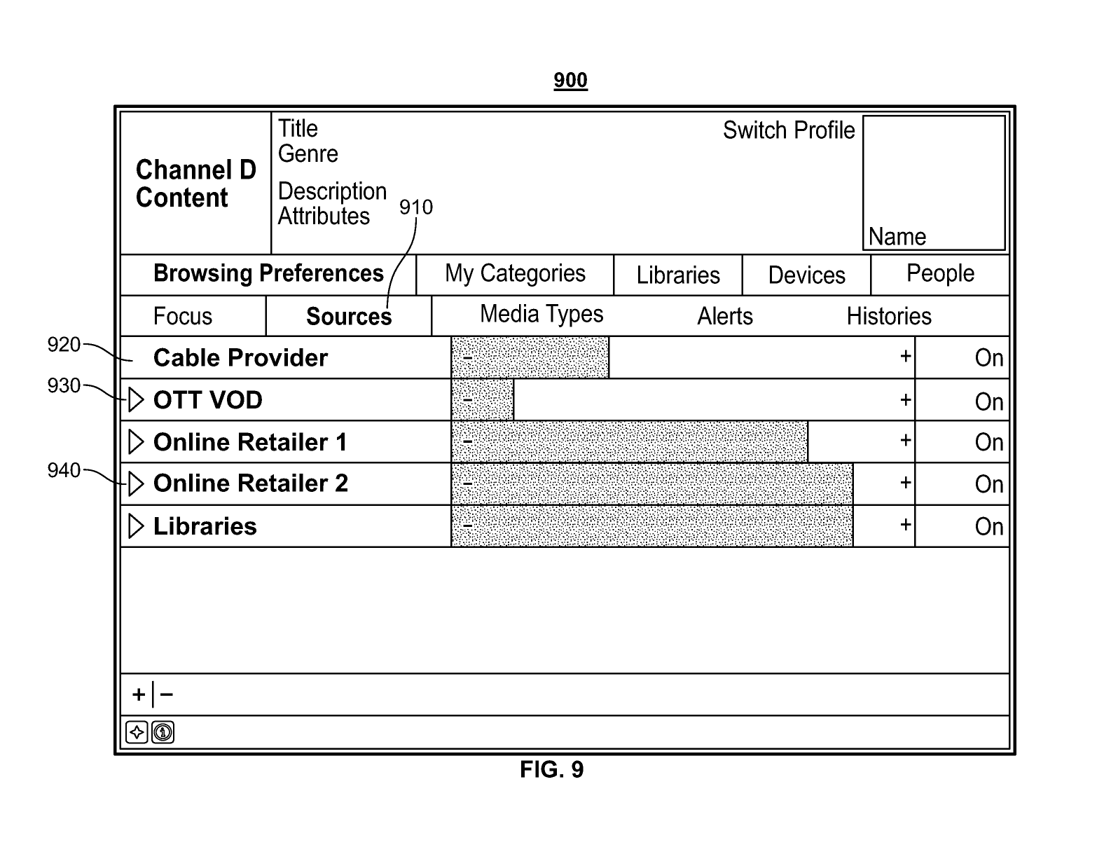

Control circuitry 304 may receive a user selection of sources criteria in criteria selection region 830. In response, control circuitry 304 may display a list of sources for which the user may provide a level of like or dislike. Specifically, in response to receiving the user selection of the sources criteria, control circuitry 304 may navigate the user to screen 900 (FIG. 9). Screen 900 includes sources criteria option 910 highlighted to indicate the user's selection. Screen 900 includes all or some of the available sources for which the user may provide a preference. Specifically, screen 900 may include a cable provider source 920, an OTT source 930 and an online source 940. The sources listed in screen 900 may be sources of media assets and/or related content.

Screen 900 may allow the user to specify a level of preference for one type of content source over another. This may indicate to control circuitry 304 whether to include related content provided by one content source rather than related content provided by another content source and/or when ranking or sorting the related content in the related content list. For example, the user may provide a level of like for cable source 920 that is greater than a level of like for OTT source 930. In such circumstances, control circuitry 304 may give more weight to the related content provided by cable sources than OTT sources when determining whether to include related content in the list of related content and/or when ranking or sorting the related content in the related content list.

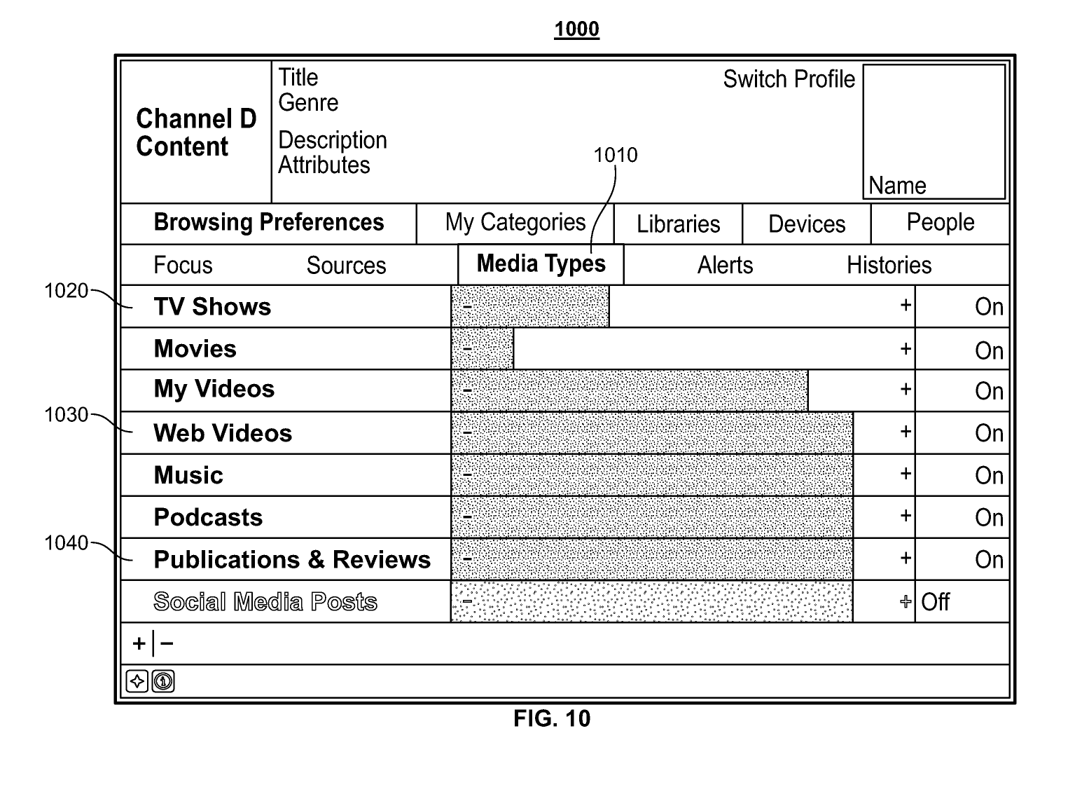

Control circuitry 304 may receive a user selection of media type criteria in criteria selection region 830. In response, control circuitry 304 may display a list of content types for which the user may provide a level of like or dislike. Specifically, in response to receiving the user selection of the media type criteria, control circuitry 304 may navigate the user to screen 1000 (FIG. 10). Screen 1000 includes media types criteria option 1010 highlighted to indicate the user's selection. Screen 1000 includes all or some of the available media types for which the user may provide a preference. For example, screen 1000 may include a television show type 1020, an website type 1030 and a publications and reviews type 1040. Any other number of types of media content may be included.

Screen 1000 may allow the user to specify a level of preference for one media type over another. This may indicate to control circuitry 304 whether to include related content of one media type rather than related content of another media type and/or when ranking or sorting the related content in the related content list. For example, the user may provide a level of like for television show type 1020 that is less than a level of like for website type 1030. In such circumstances, control circuitry 304 may give more weight to the related content of the website type 1030 than of the television show type 1020 when determining whether to include related content in the list of related content and/or when ranking or sorting the related content in the related content list. In some implementations, the user may turn OFF or instruct control circuitry 304 to exclude from consideration any one or more of the criteria discussed in connection with FIGS. 8-10.

In some embodiments, navigation through content related to a media asset may be performed using a second screen device. For example, a media asset may be displayed on a primary device (e.g., a main screen that is shared amongst users). Content related to the media asset may be identified and displayed on a second screen device (e.g., a tablet device). The related content may be selected based on a profile associated with the user and displayed on the second screen device. The second screen device may be used to interact with the media asset displayed on the primary device.

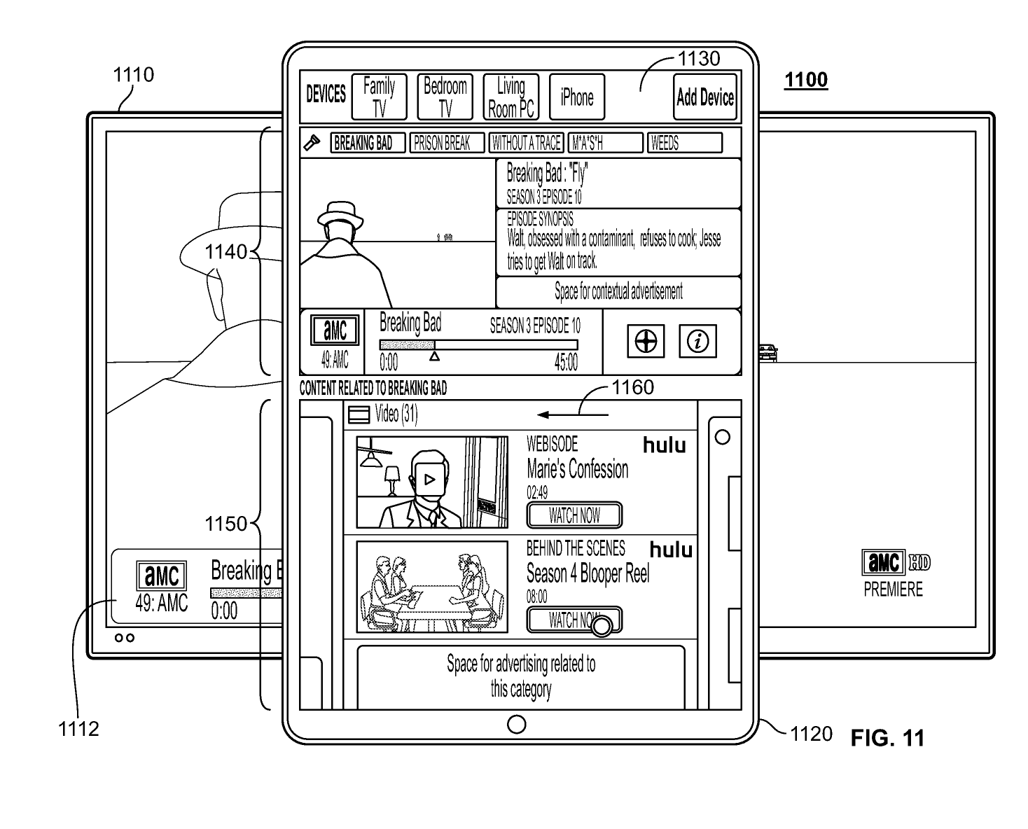

FIGS. 11-13 are illustrative systems 1100-1300 of second screen navigation of related content in accordance with another embodiment of the invention. System 1100 includes a user equipment device 1110 and a second screen device 1120. First media asset 510 may be displayed on user equipment device 1110 and a media information region 1112 may be displayed on user equipment device 1110. Media information region 1112 may identify the media asset being displayed on user equipment device 1110. For example, the media asset may be “Breaking Bad” which may be received from content source AMC on channel 49.

Second screen device 1120 may include a touch-sensitive display device. The touch-sensitive display of second screen device 1120 may display a device selection region 1130, a media asset information region 1140, and a related content navigation region 1150. Device selection region 1130 may include a set of other user equipment devices that are associated with the user. For example, device selection region 1130 may list the user equipment devices that are within a household associated with the user (e.g., a bedroom user equipment device, a living room user equipment device, a vacation home user equipment device, etc.).

Control circuitry 304 of second screen device 1120 may receive gesture indicating a user selection of one of the devices listed in region 1130. The gesture may include the receipt of a user touch on the touch-sensitive display and/or physical movement of second screen device 1120 in a given direction(s). For example, the user may touch a position on the touch-sensitive display region 1130 corresponding to the user equipment device the user is interested in controlling. In response, control circuitry 304 of second screen device 1120 may establish a connection (e.g., over communications network 414) with the selected user equipment device (e.g., a bedroom user equipment device). Control circuitry 304 of second screen device 1120 may receive an indication from the selected user equipment device of the media asset being displayed currently by the selected device. The selected device may be user equipment device 1110.

Control circuitry 304 of second screen device 1120 may display a visual representation of the media asset being displayed on the selected user equipment device in region 1140. For example, control circuitry 304 of second screen device 1120 may display the video, an image, a clip and/or a description of the media asset being displayed on the selected user equipment device. Control circuitry 304 of second screen device 1120 may receive the video of the media asset for display in region 1140 from the selected user equipment device (e.g., device 1110) and/or from an external source (e.g., the Internet) and/or from the content source of the displayed media asset. Region 1140 may include all or some of the functionality and contents displayed on user equipment device 1110. Region 1140 may include all or some of the functionality discussed in connection with FIGS. 5 and 6.

For example, region 1140 may include a window that displays a video of the media asset being accessed on user equipment device 1110. Region 1140 may include a separate region that includes a description and/or advertisement associated with the displayed media asset. Region 1140 may include a separate program information region that is the same as or similar to region 520 (FIG. 5). Region 1140 may include a separate region of representations of the content related to the media asset that matches or does not match criteria set in a profile associated with the user. This related content representation region may be the same or similar as regions 550 and 650 (FIGS. 5 and 6). The related content displayed in this region may be different from the related content displayed in user equipment device 1110 when, for example, the user profile active on the second screen device 1130 is different from the profile associated with the user active on user equipment device 1110. Accordingly, although all the available content related to the media asset displayed on user equipment device 1110 may be the same among user equipment device 1110 and second screen device 1120, the list of the related content may be different because all the available content may be filtered different based on settings of a first profile on user equipment device 1110 and settings of a second profile on second screen device 1120.

For example, the profile associated with user equipment device 1110 may specify a high level of like for action type content while the profile associated with the user of second screen device 1120 may specify a high level of like for comedy type content. In such circumstances, control circuitry 304 of user equipment device may display a first set of related content representations in region 550 (FIG. 5) that are related to the media asset being displayed and are of the type action. At the same time, control circuitry 304 of second screen device 1130 may display a second set of related content representations (different from the first set) in region 1140 that are related to the media asset being displayed and are of the type comedy.

Although region 1140 is shows as a multi-region display where each content is displayed in a separate region, the content displayed in region 1140 may be displayed on top of each other as overlays that are partially transparent or opaque similar to screen 500. For example, video of the media asset may be displayed such that is occupies the entire region 1140 and the program information region may be overlaid on top of the video in a portion of the same area.

Control circuitry 304 of second screen device 1120 may receive a gesture (e.g., touch input on the touch-sensitive display) selecting between the various contents displayed in region 1140. For example, control circuitry 304 of second screen device 1120 may receive an input in the region corresponding to the transport bar in the program information region of region 1140. In response, control circuitry 304 of second screen device 1120 may fast forward, pause, play or rewind the media asset being displayed independent of the media asset being displayed in user equipment device 1110.

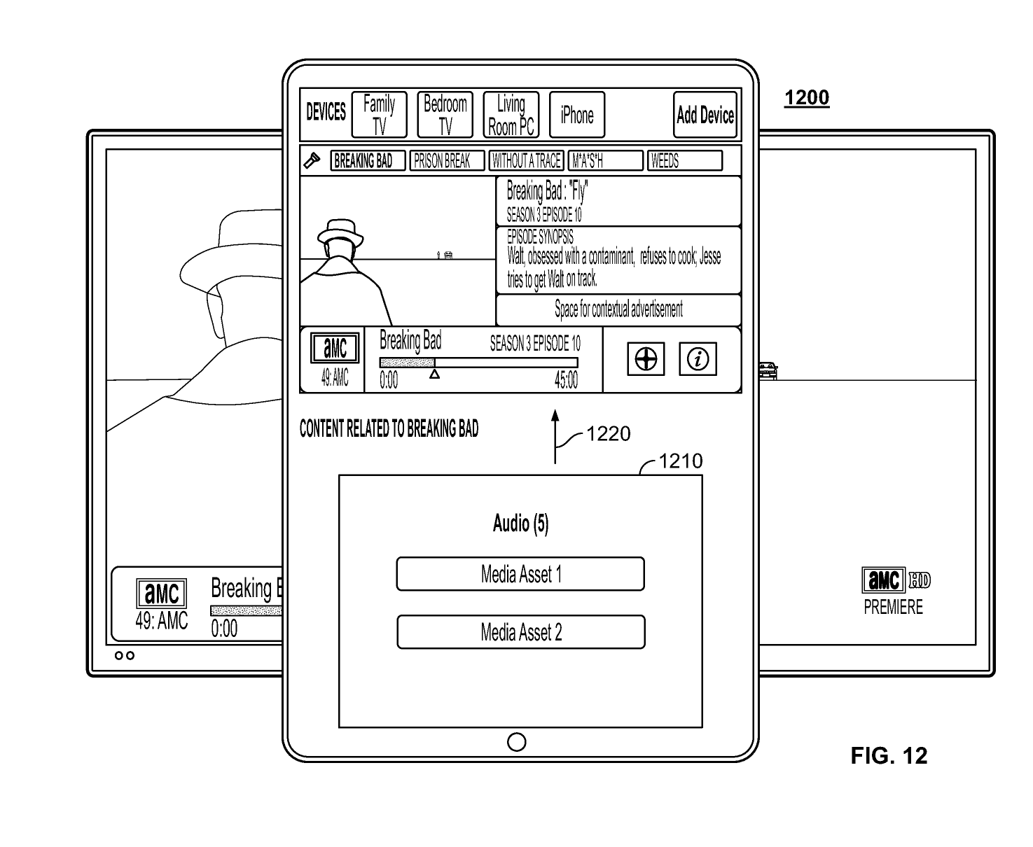

Control circuitry 304 of second screen device 1120 may display related content navigation region 1150 in the same or similar manner as region 730 (FIG. 7). In particular, the related content displayed in region 1150 may be organized or arranged according to content type. In some implementations, only one type of related content may be displayed at a time. In some implementations, multiple types of related content may be displayed at a time. In response to receiving a user gesture (e.g., a swipe along a left direction) 1160, control circuitry 304 of second screen device 1120 may slide the related content of one type (e.g., video) off the display region 1150 and slide into display region 1150 related content of a second type (e.g., audio). Screen 1200 (FIG. 12) shows the result of receiving the user gesture (e.g., swipe along a left direction) where related content of the second type 1210 (e.g., audio) is displayed.

As discussed in connection with FIG. 7, control circuitry 304 of second screen device 1120 may receive a user selection of any related content being displayed. In response, control circuitry 304 of second screen device 1120 may access and display the selected content in a full screen display of second screen device 1120 and/or prompt the user to schedule a reminder or recording of the selected content. Control circuitry 304 of second screen device 1120 may display the selected related content in place of the video being displayed in region 1140. In some implementations, control circuitry 304 of second screen device 1120 may instruct user equipment device 1110 to access and display the selected related content in place of the displayed media asset.

In response to receiving a user gesture (e.g., a swipe along a right direction), control circuitry 304 of second screen device 1120 may slide the related content of the second type (e.g., audio) off display region 1150 and slide back into display region 1150 related content of the first type (e.g., video). Specifically, while in screen 1200, the swipe along the right direction may be received and, in response, screen 1100 may be shown where the content of the first type previously displayed replaces the content of the second type in region 1150.

In response to receiving a second user gesture 1220 (e.g., a swipe along an up direction or a direction perpendicular to the direction which caused related content of different types to be displayed), control circuitry 304 of second screen device 1120 may change the media asset being displayed in region 1140 (FIG. 11). For example, user command 1220 swiping along an up direction may cause control circuitry 304 to perform the same or similar function as receipt of a user selection of one of the first set of navigation keys. Specifically, user gesture swiping in the up direction on second screen device 1120 may cause control circuitry 304 to access the next content source in the sequence of content sources while a user command swiping in the opposite substantially parallel direction (e.g., down direction) may cause control circuitry 304 to access the previous content source in the sequence.

In some embodiments, control circuitry 304 of second screen device 1120 may change the content source being accessed by both user equipment device 1110 and second screen device 1120 to the next sequential content source to display the media asset received from the next sequential content source. For example, control circuitry 304 of second screen device 1120 may instruct user equipment device 1110 to tune to the next channel (e.g., NBC on channel 50) and display the media asset received from the next channel. Control circuitry 304 of second screen device 1120 may display the media asset 1310 on user equipment device 1110 and may also display the same media asset in region 1320 on second screen device 1120.

In some embodiments, control circuitry 304 of second screen device 1120 may change only the content source being accessed by user equipment device 1110 to the next sequential content source to display the media asset received from the next sequential content source. For example, control circuitry 304 of second screen device 1120 may instruct user equipment device 1110 to tune to the next channel (e.g., NBC on channel 50) to display the media asset received from the next channel. Control circuitry 304 of second screen device 1120 may continue displaying the media asset received from the previous channel (e.g., AMC on channel 49) on second screen device 1120 while media asset 1310 is displayed on user equipment device 1110. Control circuitry 304 of user equipment device 1110 may display a program information region 1312 identifying the media asset being displayed 1310.

In some embodiments, control circuitry 304 of second screen device 1120 may change only the content source being accessed by second screen device 1120 to the next sequential content source to display the media asset received from the next sequential content source. For example, control circuitry 304 of second screen device 1120 may tune to the next channel (e.g., NBC on channel 50) and display the media asset received from the next channel. User equipment device 1110 may continue displaying the media asset received from the previous channel (e.g., AMC on channel 49) while media asset 1320 received from the next channel is displayed on second screen device 1120.

Control circuitry 304 of second screen device 1110 may update related content navigation region 1150 in response to receiving the user gesture to change the media asset being displayed by user equipment device 1110 and/or second screen device 1120. For example, control circuitry 304 may display in related content navigation region 1150 related content of a particular type 1330 (e.g., video) that correspond to media asset 1320 being displayed on second screen device 1120.

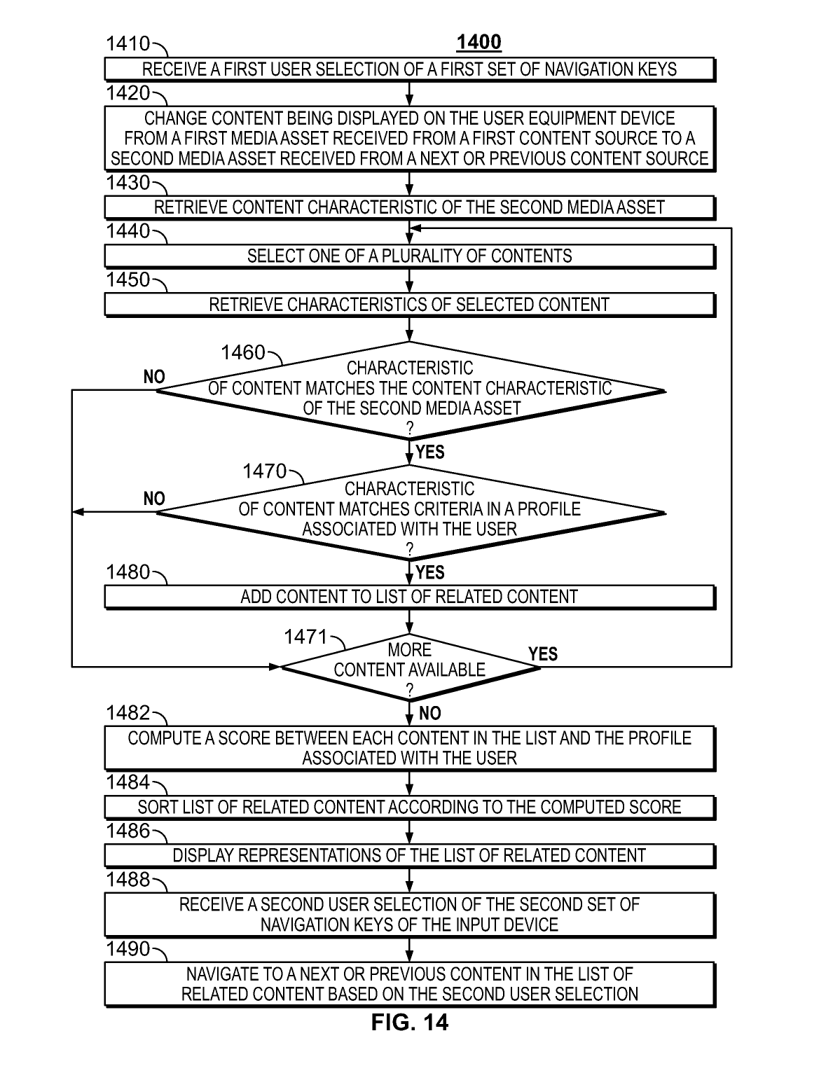

FIG. 14 is a diagram of a process 1400 for navigating through related content in accordance with embodiments of the invention. At step 1410, a first user selection of a first set of navigation keys is received. For example, a user selection of an up or down key may be received from user input interface 310 (FIG. 3).

At step 1420, content being displayed on a user equipment device is changed from a first media asset received from a first content source to a second media asset received from a next or previous content source. For example, first media asset 510 received from a first content source (e.g., channel 49) may be changed to second media asset 610 received from a second content source (e.g., channel 50) (FIGS. 5 and 6).

At step 1430, a content characteristic of the second media asset is retrieved. For example control circuitry 304 may access a content database from storage 308 and process a data structure associated with the second media asset to retrieve or extract detailed description information, category or categories associated with the second media asset, a genre of the second media asset, or any other information that defines the content of the second media asset. In some implementations, control circuitry 304 may search, using a title of the second media asset, the Internet or a website, such as IMDB or Rotten Tomatoes to identify characteristics of the second media asset.

At step 1440, one of a plurality of contents is selected. For example, control circuitry 304 may select a program, video, website, music, text or any other content stored in a content database (e.g., an electronic program guide database).

At step 1450, characteristics of the selected content is retrieved. For example, control circuitry 304 may access a content database from storage 308 and process a data structure associated with the selected content to retrieve or extract detailed description information, category or categories associated with the selected content, a genre of the second media asset, or any other information that defines the content of the selected content. In some implementations, control circuitry 304 may search, using a title of the selected content, the Internet or a website, such as IMDB or Rotten Tomatoes to identify characteristics of the selected content.

At step 1460, a determination is made as to whether the characteristics of the selected content matches the content characteristic of the second media asset. When the characteristics are determined to match, the process proceeds to step 1470, otherwise the process proceeds to step 1471. For example, control circuitry 304 may compute a Euclidian distance or score (or other mathematical function) between the retrieved characteristics of the second media asset and the characteristics of the selected content. When the computed distance or score exceeds a threshold value (which may be set by a user), control circuitry 304 may determine that a match exists between the selected content and the second media asset.

At step 1470, a determination is made as to whether the characteristics of the selected content matches criteria in a profile associated with the user. When the characteristics are determined to match, the process proceeds to step 1480, otherwise the process proceeds to step 1471. For example, control circuitry 304 may compute a Euclidian distance or score (or other mathematical function) between criteria of a profile associated with the user and the characteristics of the selected content. When the computed distance or score exceeds a threshold value (which may be set by a user), control circuitry 304 may determine that a match exists between the selected content and the profile.

At step 1480, the selected content is added to a related content list. For example, control circuitry 304 may maintain a related content list in storage 308 and may append or add the selected content or a link to the selected content in the related content list.

At step 1471, a determination is made as to whether additional content is available in a content database. When additional content is available, the process proceeds to step 1440, otherwise the process proceeds to step 1482.

At step 1482, a score is computed between each content in the list of related content and the profile associated with the user. For example, control circuitry 304 may compute a Euclidian distance or score (or other mathematical function) between criteria of a profile associated with the user and each content in the list. Control circuitry 304 may use a previously computed score that may be stored in the list together with each content.

At step 1484, the list of related content is sorted according to the computed score.

At step 1486, representations of the list of related content is displayed. For example, control circuitry 304 may display related content region 550, menu 642, and/or region 730 (FIGS. 5-7). Each of these regions may be interactive allowing the user to select any given content representation displayed to access the corresponding content.

At step 1488, a second user selection is received of the second set of navigation keys of the input device. For example, a user selection of a left or right key may be received from user input interface 310 (FIG. 3).

At step 1490, a next or previous content in the list of related content is navigated to based on the second user selection. For example, control circuitry 304 may access the list of related content, determine a current position in the list and access or display the content corresponding to the next or previous content in the list relative to the current position. When first media asset 510 is being displayed, a right key selection may cause the first content in the list to be accessed as the “next” content (since no related content has been accessed yet) and a left key selection may cause the last content in the list to be accessed as the “previous” content in the list.

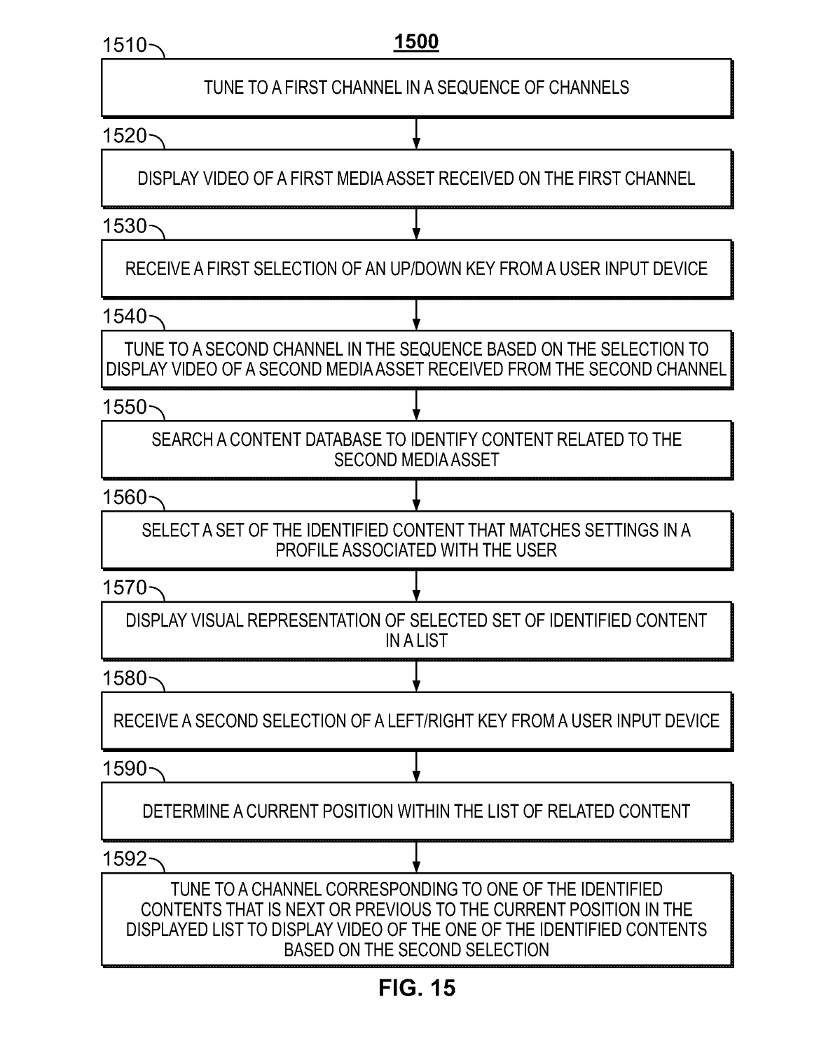

FIG. 15 is a diagram of a process 1500 for navigating through related content in accordance with embodiments of the invention. At step 1510, a first channel in a sequence of channels is tuned to.

At step 1520, video of a first media asset received on the first channel is displayed.

At step 1530, a first selection of an up/down key is received from a user input device.

At step 1540, a second channel in the sequence is tuned to based on the selection to display video of a second media asset received from the second channel.

At step 1550, a content database is searched to identify content related to the second media asset (e.g., by subject-matter).

At step 1560, a set of the identified content is selected that matches settings (or criteria) in a profile associated with the user.

At step 1570, a visual representation of the selected set of identified content is displayed in a list.

At step 1580, a second selection of a left/right key is received from a user input device.

At step 1590, a current position in the list of related content is determined.

At step 1592, a channel corresponding to one of the identified contents that is next or previous to the current position in the displayed list is tuned to for displaying video of the one of the identified contents based on the second selection.

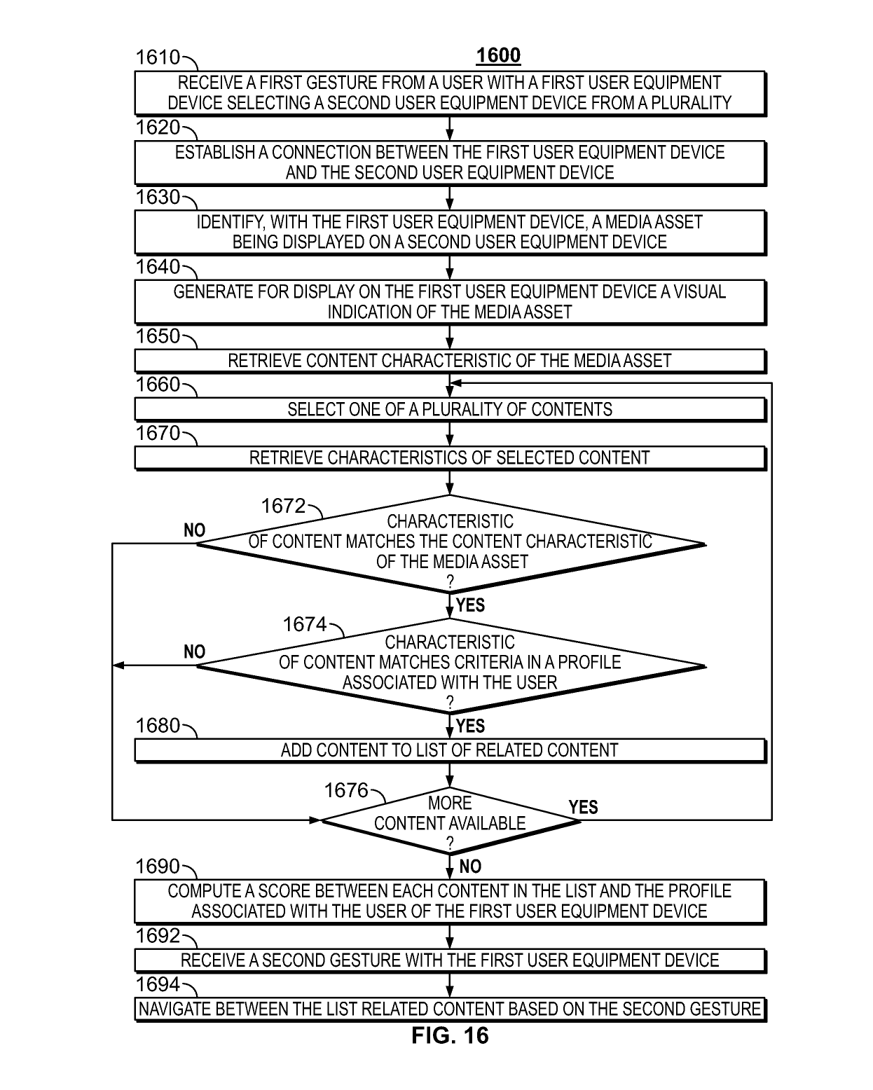

FIG. 16 is a diagram of a process 1600 for navigating through related content in accordance with embodiments of the invention. At step 1610, a first gesture is received from a user with a first user equipment device selecting a second user equipment device from a plurality. For example, control circuitry 304 of second screen device 1120 may receive actuation of the touch-sensitive display in a position corresponding to one of a plurality of user equipment devices listed in region 1130 (FIG. 11).

At step 1620, a connection is established between the first user equipment device and the second user equipment device. For example, control circuitry 304 of second screen device 1120 may communicate with user equipment device 1110 over communications network 414 (FIG. 4).

At step 1630, a media asset being displayed on the second user equipment device is identified with the first user equipment device.

At step 1640, a visual indication of the media asset is generated for display on the first user equipment device. For example, control circuitry 304 of second screen device 1120 may display in program information region 1140 video, audio, text, description, image or any other information that identifies the media asset to a user.

At step 1650, a content characteristic of the media asset is retrieved. For example control circuitry 304 of second screen device 1120 may access a content database from storage 308 and process a data structure associated with the media asset to retrieve or extract detailed description information, category or categories associated with the media asset, a genre of the media asset, or any other information that defines the content of the media asset. In some implementations, control circuitry 304 of second screen device 1120 may search, using a title of the second media asset, the Internet or a website, such as IMDB or Rotten Tomatoes to identify characteristics of the media asset.

At step 1660, one of a plurality of contents is selected. For example, control circuitry 304 of second screen device 1120 may select a program, video, website, music, text or any other content stored in a content database (e.g., an electronic program guide database).

At step 1670, characteristics of the selected content is retrieved. For example, control circuitry 304 of second screen device 1120 may access a content database from storage 308 and process a data structure associated with the selected content to retrieve or extract detailed description information, category or categories associated with the selected content, a genre of the second media asset, or any other information that defines the content of the selected content. In some implementations, control circuitry 304 of second screen device 1120 may search, using a title of the selected content, the Internet or a website, such as IMDB or Rotten Tomatoes to identify characteristics of the selected content.

At step 1672, a determination is made as to whether the characteristics of the selected content matches the content characteristic of the second media asset. When the characteristics are determined to match, the process proceeds to step 1674, otherwise the process proceeds to step 1676. When the characteristics are determined to match, the process proceeds to step 1470, otherwise the process proceeds to step 1471. For example, control circuitry 304 of second screen device 1120 may compute a Euclidian distance or score (or other mathematical function) between the retrieved characteristics of the media asset and the characteristics of the selected content. When the computed distance or score exceeds a threshold value (which may be set by a user), control circuitry 304 of second screen device 1120 may determine that a match exists between the selected content and the media asset.

At step 1674, a determination is made as to whether the characteristics of the selected content matches criteria in a profile associated with the user. When the characteristics are determined to match, the process proceeds to step 1680, otherwise the process proceeds to step 1676. For example, control circuitry 304 of second screen device 1120 may compute a Euclidian distance or score (or other mathematical function) between criteria of a profile associated with the user of second screen device 1120 and the characteristics of the selected content. When the computed distance or score exceeds a threshold value (which may be set by a user), control circuitry 304 of second screen device 1120 may determine that a match exists between the selected content and the profile.

At step 1680, the selected content is added to a related content list. For example, control circuitry 304 of second screen device 1120 may maintain a related content list in storage 308 and may append or add the selected content or a link to the selected content in the related content list.

At step 1676, a determination is made as to whether additional content is available in a content database. When additional content is available, the process proceeds to step 1660, otherwise the process proceeds to step 1690.

At step 1690, a score is computed between each content in the list of related content and the profile associated with the user. For example, control circuitry 304 of second screen device 1120 may compute a Euclidian distance or score (or other mathematical function) between criteria of a profile associated with the user and each content in the list. Control circuitry 304 of second screen device 1120 may use a previously computed score that may be stored in the list together with each content.

At step 1692, a second gesture is received with the first user equipment device. For example, control circuitry 304 of second screen device 1120 may receive actuation of the touch-sensitive display that is a swipe 1160 along the screen in a particular direction (e.g., left swipe gesture or right swipe gesture) (FIG. 11).

At step 1694, the list of related content is navigated based on the second gesture. For example, control circuitry 304 of second screen device 1120 may access the list of related content, determine a current position in the list and access or display the content corresponding to the next or previous content in the list relative to the current position. When a media asset is being displayed in region 1140, a swipe gesture in the right direction may cause the first content in the list to be accessed as the “next” content (since no related content has been accessed yet) and a swipe gesture in the left direction may cause the last content in the list to be accessed as the “previous” content in the list.

It should be understood, that the above steps of the flow diagrams of FIGS. 14-16 may be executed or performed in any order or sequence not limited to the order and sequence shown and described in the figures. Also, some of the above steps of the flow diagrams of FIGS. 14-16 may be executed or performed substantially simultaneously where appropriate or in parallel to reduce latency and processing times.

The above described embodiments of the present disclosure are presented for purposes of illustration and not of limitation, and the present disclosure is limited only by the claims which follow.

1. A method for operating a user equipment device having an input device with a first set of navigation keys and a second set of navigation keys, wherein the user equipment device receives content from a plurality of content sources, the method comprising:
changing, based on receiving a first user selection of the first set of navigation keys, content being displayed on the user equipment device from a first media asset received from a first content source of the plurality of content sources to a second media asset received from a second content source of the plurality of content sources;
receiving a second user selection of the second set of navigation keys of the input device, wherein the second user selection is received while the second media asset is being displayed; and
searching for a plurality of content that is related to the second media asset;
identifying a set of the plurality of content that corresponds to a profile associated with the user; and
navigating between the identified set of the plurality of content based on the second user selection.

2. The method of claim 1, wherein the first set of navigation keys includes a channel-up command and a channel-down command and wherein the second set of navigation keys includes a left navigation command and a right navigation command.

3. The method of claim 1, wherein the plurality of content sources include a plurality of television channels.

4. The method of claim 1, wherein the plurality of content sources is sequentially arranged, and wherein the second media asset follows the first media asset in the sequence.

5. The method of claim 1, wherein searching for the plurality of content that is related to the second media asset comprises:
determining a content characteristic of the second media asset;
searching for content that is associated with the determined content characteristic.

6. The method of claim 5, wherein searching for content comprises searching over the Internet to identify the content based on the content characteristic.

7. The method of claim 1, wherein one of the plurality of content is a website, a media asset, a video, textual content, audio content, on-demand content, broadcast content, Internet content, or an advertisement.

8. The method of claim 1, wherein the profile associated with the user includes at least one of a first viewing history of the user, a second viewing history of another user, and a preference of the user.

9. The method of claim 1, wherein identifying the set of the plurality of content comprises identifying the set based on at least one of a time of day, another device within a range of the user equipment device, and another user within a range of the user equipment device.

10. The method of claim 1, wherein:
the plurality of content includes content received from another of the plurality of content sources different from the second content source; and
the plurality of content is sequentially arranged; and
navigating comprises visually identifying each of the plurality of content sequentially responsive to receipt of user selections of the second set of navigation keys.

11. A system for operating a user equipment device having an input device with a first set of navigation keys and a second set of navigation keys, wherein the user equipment device receives content from a plurality of content sources, the system comprising:
control circuitry configured to:
change, based on receiving a first user selection of the first set of navigation keys, content being displayed on the user equipment device from a first media asset received from a first content source of the plurality of content sources to a second media asset received from a second content source of the plurality of content sources;
receive a second user selection of the second set of navigation keys of the input device, wherein the second user selection is received while the second media asset is being displayed; and
search for a plurality of content that is related to the second media asset;
identify a set of the plurality of content that corresponds to a profile associated with the user; and
navigate between the identified set of the plurality of content based on the second user selection.

12. The system of claim 11, wherein the first set of navigation keys includes a channel-up command and a channel-down command and wherein the second set of navigation keys includes a left navigation command and a right navigation command.

13. The system of claim 11, wherein the plurality of content sources include a plurality of television channels.

14. The method of claim 11, wherein the plurality of content sources is sequentially arranged, and wherein the second media asset follows the first media asset in the sequence.

15. The system of claim 11, wherein the control circuitry is further configured to:
determine a content characteristic of the second media asset;
search for content that is associated with the determined content characteristic.

16. The system of claim 15, wherein the control circuitry is further configured to search over the Internet to identify the content based on the content characteristic.

17. The system of claim 11, wherein one of the plurality of content is a website, a media asset, a video, textual content, audio content, on-demand content, broadcast content, Internet content, or an advertisement.

18. The system of claim 11, wherein the profile associated with the user includes at least one of a first viewing history of the user, a second viewing history of another user, and a preference of the user.

19. The system of claim 11, wherein the control circuitry is further configured to identify the set based on at least one of a time of day, another device within a range of the user equipment device, and another user within a range of the user equipment device.

20. The system of claim 11, wherein:
the plurality of content includes content received from another of the plurality of content sources different from the second content source; and
the plurality of content is sequentially arranged; and
the control circuitry is further configured to visually identifying each of the plurality of content sequentially responsive to receipt of user selections of the second set of navigation keys.

21-30. (canceled)
